(19) United States
(12) Patent Application Publication
(10) Pub. No.: US 2005/0242558 A1
(43) Pub. Date: Nov. 3, 2005

(54) Bumper apron/protector

(76) Inventor: Cynthia Jean Cohen, Winter Park, FL (US)

Correspondence Address: Cynthia Jean Cohen, 483 Lakewood Drive, Winter Park, FL, 32789, US

(21) Appl. No.: 10/760,159

(22) Filed: May 3, 2004

(51) Int. Cl. B60R 1/00

(52) U.S. Cl. 280/770

(57) ABSTRACT

The BUMPER APRON/PROTECTOR is a protective mat made from a variety of materials ranging from cloth to leather. Once it is attached in place in the trunk or rear cargo area of a vehicle, the unattached end can be simply grasped, pulled out of the vehicle's trunk/cargo space and dropped down over the bumper where it serves two functions: 1. it protects the rear bumper from being nicked, scratched or dinged as articles, such as golf bags and golf clubs, are dropped or rubbed across the bumper as they are being placed into and out of the vehicle's trunk or cargo space area and 2. it functions as a clean surface on which a person may sit when performing any function requiring a seated position such as changing from street shoes to golf shoes.

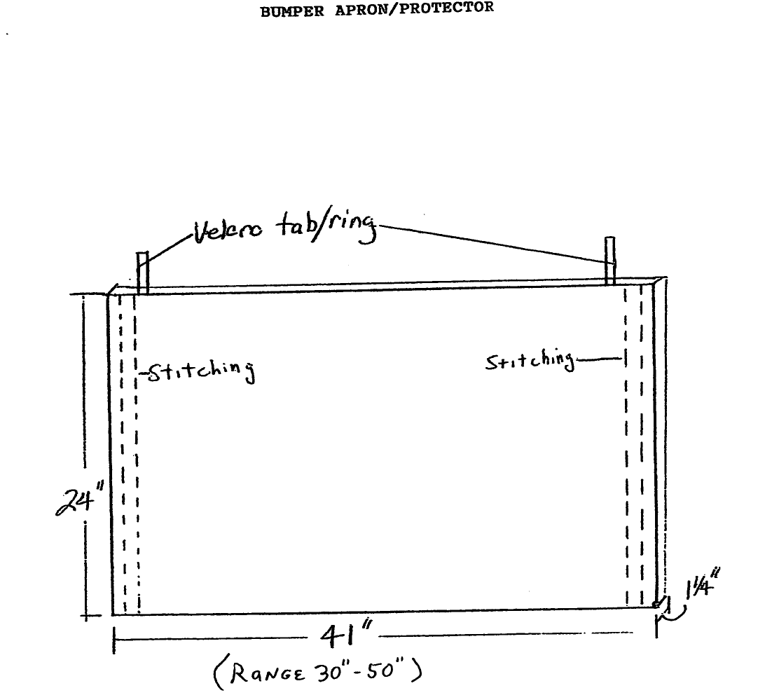

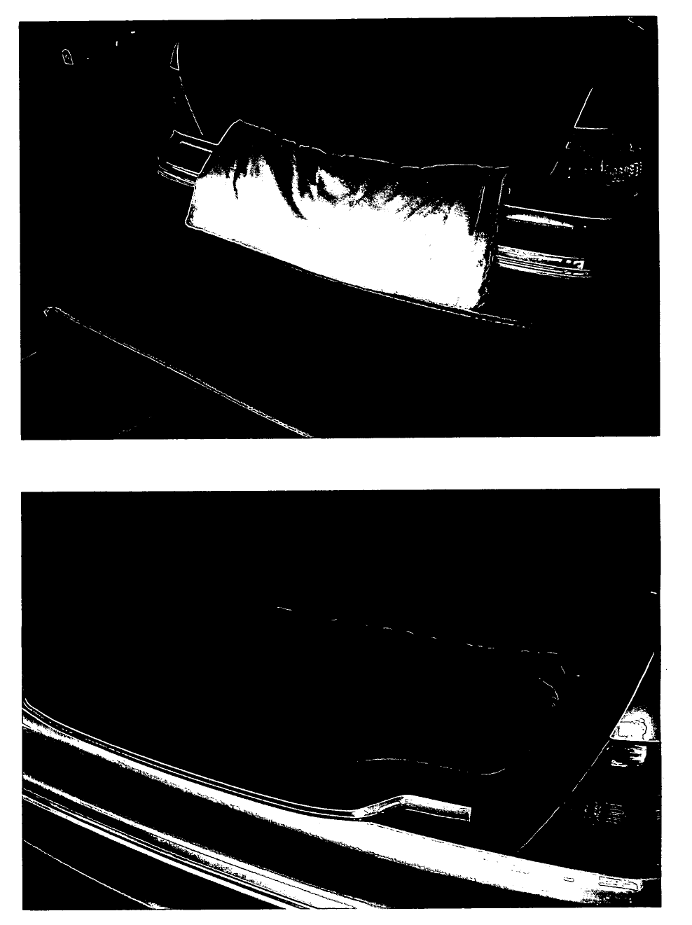

A protective mat of an approximate size of 41″×24″×1¼″ (range 30-50″) but which can be made to custom sizes for any specified vehicle.

The apron functions to protect the rear bumper from nicks, scratches, and dents as articles, such as golf clubs, are dropped onto or rubbed across the bumper as they are placed into and out of the vehicle's trunk or cargo space area.

The apron is constructed of two outer layers of cotton duck, plastic coated fabric, vinyl, naugahide, leather from any animal source, or like materials which are sewn together and stuffed with an approximately 1″ thickness of batting/padding. Alternatively, the apron may be constructed to all the same specifications and sizes except being constructed of only a single layer of fabric instead of the multi-three layer construction.

Adjustable, double-sided Velcro tape at the two upper corners of the apron are utilized to attach the apron to the inside of the car trunk or back of the SUV (sport utility vehicle) or minivan cargo space area. If the selected vehicle to be protected has it's own built in trunk/cargo space loops or rings, then the apron's double-sided Velcro tape can be slipped through the ring/hook and be attached to itself for the purpose of holding the apron in place. If the vehicle does not contain potential attachment sites, the Velcro can be attached to the vehicles carpeted floor. If the vehicle has a hard surfaced floor, then self adhesive Velcro can be glued to the floor and the apron's Velcro then attached to it. Metal or plastic mechanical hooks or rings can be sewn into the two upper corners of the apron lieu of the double-sided Velcro to be used to attach the apron to the cargo space of vehicles factory equipped with attachment sites suitable for utilization of these rings or hooks.

Several rows of vertical stitching can be placed at 2″ intervals beginning at each lateral border and moving toward the center of the mat, thus allowing the mat to be cut off to fit a smaller size vehicle opening, if desired.

Once attached in place, the apron is laid flat in the trunk or cargo space. Then prior to placing any articles into the vehicle, the unattached end of the apron is simply grasped, pulled out of the vehicle's trunk/cargo space, and dropped down over the bumper—thus protecting the bumper as the articles are placed into the trunk or cargo space. Once the articles are inside the vehicle's trunk/cargo area, the apron is then placed back into the vehicle by lifting up the unattached end and draping the apron over the articles now situated in the trunk or cargo space. When the articles are to be removed, the process is repeated as the apron is once again withdrawn and draped over the bumper, thus protecting the bumper as the articles are removed from the vehicle.

The mat will be produced in a variety of colors and materials along with personalized designs, pictures, slogans, logos, and wordings available to be placed on the apron's outer surface, either top layer, bottom layer or both, through any known process such as, but not limited to, painting, staining, stitching, embroidering, embossing, burning or tooling.

1. I claim that The BUMPER APRON/PROTECTOR will function to protect the rear bumper of the vehicle into which it is installed from being nicked, scratched or dinged as articles, such as golf bags and golf clubs, are dropped onto or rubbed across the bumper as they are being placed into and out of the vehicle's trunk or cargo space area

2. I claim that the BUMPER APRON/PROTECTOR will function to provide a clean surface on which a person may sit when performing any function requiring a seated position such as changing from street shoes to golf shoes.
